(19) United States
(12) Patent Application Publication
(10) Pub. No.: US 2003/0005212 A1
(43) Pub. Date: Jan. 2, 2003

(54) Method and apparatus for dynamically modifying a stored program

(76) Inventor: J. David Cocca, Chapel Hill, NC (US)

Correspondence Address: Michael G. Savage, BURNS, DOANE, SWECKER & MATHIS, L.L.P., P.O. Box 1404, Alexandria, VA, 22313-1404, US

(21) Appl. No.: 09/896,780

(22) Filed: Jun. 29, 2001

(51) Int. Cl. G06F 12/00

(52) U.S. Cl. 711/103

(57) ABSTRACT

Method and apparatus for dynamically modifying a stored program are presented. Correction code is stored in at least one of a plurality of correction blocks included in an electrically erasable programmable memory. A program having instructions stored in the memory is then executed. An address match routine is invoked to execute at least a portion of the correction code in place of at least one of the instructions during the executing of the program. The executing of the program continues after the at least a portion of the correction code is executed.

### BACKGROUND

This invention relates to a method and apparatus for dynamically modifying a stored program. In particular, this invention relates to a method and apparatus for dynamically modifying a program stored in electrically erasable programmable memory using a micro-controller unit (MCU) having address match interrupt capability.

Read-Only Memory (ROM) is a mature, high-density, nonvolatile, reliable, and low-cost memory technology widely used in the 1980s in the PC industry and in other embedded applications to store computer operating instructions or programs. Initial ROM programming involves a complex, time-consuming, mask development process that produces a static memory storage device, the contents of which cannot be altered once the ROM is manufactured. Should an error, or inefficiency be discovered in the instructions programmed into the ROM, a new modified ROM must be manufactured to effect an instruction change. The costs of manufacturing a modified ROM to implement an instruction change, as well as the delay associated with producing such a modified ROM, raised the need for an improved method of modifying the instructions programmed into ROMs.

To address this need, Mitsubishi developed a single-chip microcomputer in which instructions or other like programs are set in a mask ROM, the microcomputer having the capability to avoid errors in the set instructions or programs without replacing the ROM. The operation of the single-chip microcomputer is described in U.S. Pat. No. 5,051,897 to Yamaguchi et al. (“Yamaguchi”), assigned to the same assignee as this patent application, and entitled “Single-Chip Microcomputer with Memory Patching Capability”, the written description of which is incorporated by reference.

Yamaguchi describes a microcomputer having an address match interrupt capability. First, a leading address of an instruction set or a program stored in a ROM requiring correction is written into a programmable ROM (PROM). This leading address is then loaded into a register, the contents of which are compared with the output of a programmable address counter using a coincidence circuit. When the register contents and programmable address counter output match, an interrupt signal is generated by the coincidence circuit and forwarded to a central processing unit (CPU). The CPU then instructs an I/O device to begin loading correction instructions from an external source into the PROM. The correction instructions are stored at an address location within the PROM transmitted with the interrupt signal. Thereafter, the CPU processes corrected instructions from the PROM until a correction instruction is received directing the CPU to return to processing instructions from the ROM.

The end result is a ROM-based microcomputer system where instructions programmed into the ROM can be easily modified (or replaced) without the need for manufacturing a completely new ROM device. At the time of its inception, Yamaguchi's system offered significant cost and design advantages over previous ROM-based systems, and remains an important development in microcomputer architecture today. Still, recent advances in memory technology have presented opportunities for the development of advanced address match interrupt microcomputer functionality and designs.

Once such electrically erasable programmable memory technology particularly suited for use in address match interrupt microcomputer architectures is the high-performance, read-write memory solution known as flash memory. Introduced in the late 1980s, flash memory offers a high-density, truly nonvolatile, and flexible alternative to ROM devices. Unlike ROM devices, flash memory is electrically erasable “in system”, offering both developers and users of flash memory based MCUs the flexibility of re-writing the code (or firmware) often preprogrammed into the device.

Not unsurprisingly, however, the erasure and reprogramming of flash memory does not come without a price. Rewriting all of the memory locations in a typically-sized flash memory device requires a significant amount of time and energy. For example, it may take up to fifteen minutes to rewrite an entire 256K flash memory at a data rate of 2400 baud. Requiring this amount of time to reprogram the flash memory can be problematic, especially when performing field updates to the firmware installed in today's portable, limited battery-powered, microprocessor-based devices. Because these portable devices must be powered on during the reprogramming process, reducing the amount of time required to effect a programming correction will reduce the amount of battery loss.

The reprogramming process is particularly wasteful when an entire flash memory is reprogrammed to correct for only a limited number of instructions of an already stored program. Reprogramming an entire flash memory is also much more likely to result in the occurrence of programming errors than merely updating a limited set of instructions. This is particularly true when transferring large numbers of instructions over certain transmission media, such as over the PSTN (i.e., phone lines), or by radio-frequency (RF) transmission. Moreover, sending only a limited set of instructions would allow low-cost transfer technologies, e.g., low-speed modem technology, to be used to effect program corrections, without having large reprogramming times.

Therefore, there exists a need for a electrically erasable programmable memory based MCU having address match interrupt capability to reduce the amount of time, energy and errors in reprogramming the software stored in the erasable memory.

### SUMMARY

It is therefore an object of the present invention to provide methods and apparatus for programming and executing correction software or code in electrically erasable programmable memory based MCUs.

In accordance with one aspect of the invention, the foregoing and other objects are achieved in a method for dynamically modifying a stored program, the method including the steps of storing correction code in at least one of a plurality of correction blocks included in an electrically erasable programmable memory; executing a program having instructions stored in the memory; invoking an address match routine to execute at least a portion of the correction code in place of at least one of the instructions during the executing of the program; and continuing executing the program after the at least a portion of the correction code executes.

According to another aspect of the invention the invoking of an address match routine occurs when a program counter associated with the executing of the program matches at least one of a plurality of address match registers.

According to yet another aspect of the invention, the method includes the steps of determining for each of the correction blocks whether correction code stored in the blocks is to be executed during the executing of the program; retrieving a first address from the correction code stored in a respective correction block when it is determined that correction code stored in the respective correction block is to be executed during program execution; and storing the retrieved first address in one of the plurality of address match registers.

According to yet another aspect of the invention, the step of determining for each of the correction blocks whether correction code stored in a respective correction block is to be executed during program execution includes the steps of retrieving a first data value from each of the correction blocks having stored correction code; comparing the retrieved first data value from each of the correction blocks having stored correction code to a predetermined value; and determining that the correction code stored in each of the correction blocks is to be executed during program execution when the corresponding first data value equals the predetermined value, otherwise determining that the correction code stored in each of the correction blocks is not to be executed during program execution.

According to yet another aspect of the invention, the step of determining for each of the correction blocks whether correction code stored in the blocks is to be executed during the executing of the program occurs in response to a completion of the storing of correction code in at least one of a plurality of correction blocks.

According to yet another aspect of the invention, the method includes the steps of saving a plurality of registers and the program counter upon the invoking of the address match routine to preserve a post address match program status; retrieving a second data value from each of the correction blocks having stored correction code; comparing the retrieved second data value from each of the correction blocks having stored correction code to a post address match value of the program counter; and identifying the correction block corresponding to the invoking of the address match routine as the correction block having the second data value equal to the post address match value of the program counter.

According to yet another aspect of the invention, the method includes the step of branching to an error processing routine when no retrieved second data value is equal to the post address match value of the program counter.

According to yet another aspect of the invention, the second data value is equal to the value stored in the address match register corresponding to the invoking of the address match routine plus an offset value. The offset value may depend upon a next program instruction to be executed at the time of the invoking of the address match routine.

According to yet another aspect of the invention, the step of continuing executing the program after the at least a portion of the correction code executes includes the steps of retrieving a third address from the correction code identifying a return address within the program; restoring the plurality of registers saved upon the invoking of the address match routine to reinstate a post address match program status; branching the executing of the program to the third address; and executing the program having instructions stored in the memory beginning at the third address.

According to yet another aspect of the invention, the invoking of the address match routine is carried out by an address match interrupt service routine having a corresponding address match interrupt entry in a vector table stored in the memory.

According to yet another aspect of the invention, to execute at least a portion of the correction code, the address match routine includes the steps of retrieving a second address from the correction code identifying a starting address within the at least a portion of correction code; branching the executing of the program to the second address; and executing the at least a portion of the correction code beginning at the second address.

According to yet another aspect of the invention, instructions for continuing executing the program after the at least a portion of the correction code executes are included in the correction code.

According to yet another aspect of the invention, the step of storing correction code in at least one of a plurality of correction blocks includes the steps of selecting at least one of the plurality of correction blocks for storing the correction code; erasing the selected at least one memory correction block; and transferring the correction code from an external source to the selected at least one of the plurality of correction blocks. The correction code may be transferred from the external source by at least one of a wired and a wireless connection.

According to yet another aspect of the invention, the step of storing correction code in at least one of a plurality of correction blocks occurs in response to at least one of a detection that an external source is coupled to the memory and an invocation of a periodically scheduled maintenance routine.

According to yet another aspect of the invention, an electrically erasable programmable memory based memory map structure supporting an address match interrupt scheme, includes a plurality of correction blocks for storing correction code; a random access memory (RAM) area including a program stack for temporarily storing program information; a main program area for storing at least one executable program; an initialization area for storing code to enable an address match interrupt for at least one of the correction blocks; a special function register (SFR) area including a plurality of address interrupt registers; a vector table for triggering the address match interrupt when a program counter associated with the at least one executable program matches a register value stored in one of the plurality of address interrupt registers; and an interrupt service routine (ISR) area including an address match ISR. The address match ISR identifies which one of the plurality of correction blocks corresponds to the triggering of the address match interrupt to execute at least a portion of the correction code in place of at least one instruction of the at least one executable program during program execution.

According to yet another aspect of the invention, each of the correction blocks include a first data value for determining whether correction code stored in the correction block is to be executed during program execution; a second data value for identifying which one of the plurality of correction blocks corresponds to the triggering of the address match interrupt; a first address identifying a location of the portion of the executable program replaced by the at least a portion of the correction code; a second address identifying a starting address of the at least a portion of the correction code to be executed in place of the least a portion of the executable program; and a third address identifying a return address within the executable program where program execution is continued after execution of the at a portion of the correction is completed.

### BRIEF DESCRIPTION OF THE DRAWINGS

The objects and advantages of the invention will be understood by reading the following detailed description in conjunction with the drawings in which:

FIG. 1 is a block diagram of a typical memory map for a flash memory MCU;

FIG. 2 depicts a block diagram of the flash memory portion of the memory map comprising a flash memory correction block, and depicts a manner in which the correction block may be programmed according to one aspect of the invention;

FIG. 3 is a flow chart depicting a manner in which the correction block may be programmed according to one aspect of the invention; and

FIG. 4 is a flow chart depicting a manner in which address match interrupts are generated and enabled;

FIG. 5 is a flow chart depicting a manner in which programs stored in the flash memory are executed using address match interrupt capability in the MCU;

FIG. 6 is a flow chart depicting a manner in which an address match interrupt subroutine is executed according to one aspect of the invention; and

FIG. 7 depicts a more detailed view of the memory map of FIG. 1, and an expanded view of a correction block.

### DETAILED DESCRIPTION

The various features of the invention will now be described with respect to the figures, in which like parts are identified with the same reference characters.

While the following exemplary embodiments describe the programming and use of correction software or code in flash memory MCUs, it will be understood that the invention may be practiced using any suitable electrically erasable programmable memory technology.

Correction software or code is programmed into a correction block of a flash memory. The correction code includes a starting address (address match correction start address) and an ending address (correction return address) of a portion of a software program stored in the flash memory that is to be corrected. Address match interrupt registers are set based on the address match correction start address. The program executes normally until a program counter matches an address match interrupt register entry. When an address match occurs, an interrupt is generated, and an address match interrupt service routine (ISR) is executed. The ISR stores register values to the program stack and sets a return from interrupt address equal to the correction return address. The correction code is then executed. Once completed, a return from interrupt command sets the program counter to the correction return address and normal program execution continues until another address match interrupt occurs.

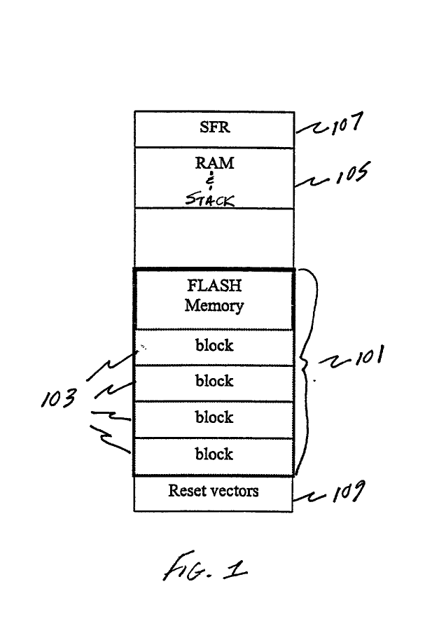

The various aspects of the invention will now be further described in connection with a number of exemplary embodiments. Referring first to FIG. 1, this is a block diagram of a typical memory map for a flash memory MCU. The memory map includes a flash memory portion 101, comprising several flash memory blocks 103. Unlike other types of electrically alterable memory such as static random access memory (SRAM), dynamic RAM (DRAM), or electrically erasable PROM (EEPROM), flash memory is not byte erasable. Instead, flash memory is typically organized into units of blocks that can be electrically erased. The flash memory is typically writeable by units of words or pages. Blocks typically comprise 4, 8, 16, 32, or 64K bytes of addressable memory.

In addition to the flash memory portion 101, the memory map shown in FIG. 1 also includes a RAM portion 105, which may comprise DRAM and/or SRAM. Also included in the memory map is a special function register (SFR) 107 used for storing status control information, and data used by peripherals (e.g., timers, A/D converters) connected to the MCU. The SFR 107 is also used to store the address match correction start addresses for the various address match interrupts. The memory map further includes a vector table 109, used to select the address match ISR whenever an address match occurs.

Because flash memory is organized into units of blocks, it is most practical to store the correction code that is programmed into the MCU into blocks as well. One or more consecutive or non-consecutive memory blocks may be used to store each portion of correction software. The correction block(s) are preferably set up to use the smallest addressable block size available, e.g., 4K block(s), but any block size may be used. Depending on the interrupt capabilities of the MCU, several portions of correction software, or “patches”, may be stored in the system's flash memory. This capability enables the system to correct for several relatively small (in terms of the number of commands needed to correct an error) program errors, without the need to reprogram the entire flash memory with an updated software program.

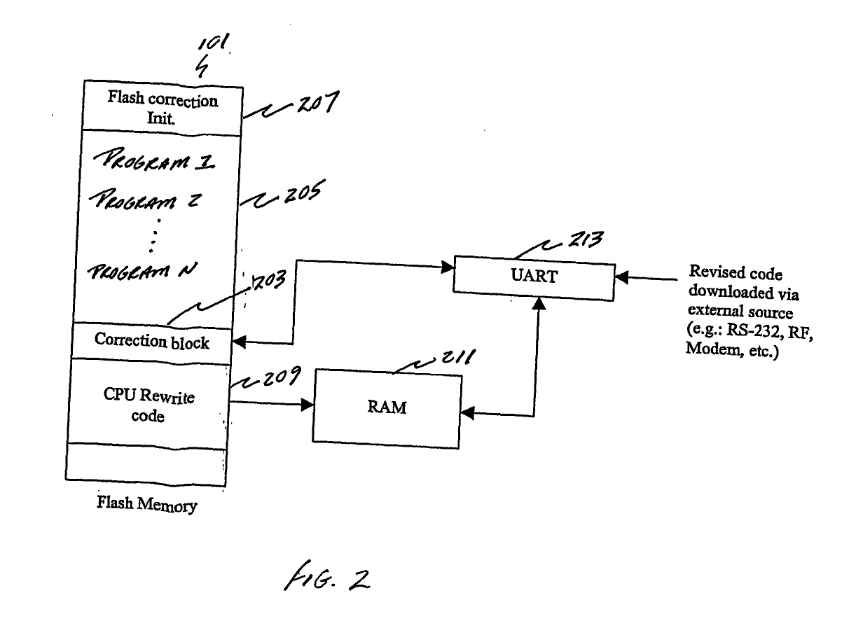

FIG. 2 depicts a block diagram of the flash memory portion 101 of the memory map shown in FIG. 1, and depicts a manner in which the correction block may be programmed according to one aspect of the invention. The flash memory 101 comprises one or more blocks 203 where the correction code is stored, several blocks where the program (or programs) to be corrected 205 is stored, and blocks of memory where flash memory correction initialization commands 207 and CPU rewrite code 209 are stored. As stated above, the correction code 203 may stored in several blocks, and the flash memory may be used to store several different patches for one or more programs 205 stored in the memory. The flash correction initialization code 207 may be used to store commands that are common to the execution of all patches stored in the memory. For example, the code may comprise commands to determine if correction code has been stored in a designated correction code block. The initialization code 207 may also comprise commands to set the address match interrupt registers, and to enable the interrupts.

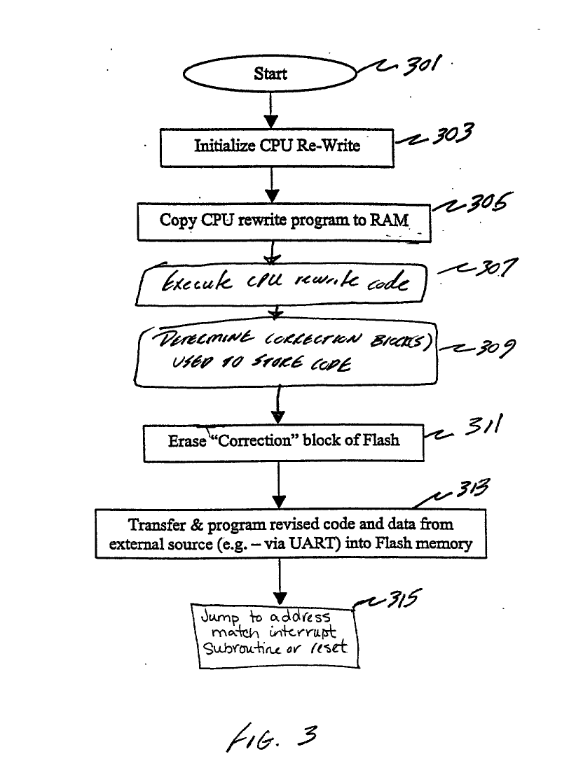

FIG. 2 also depicts a RAM 211 used to temporarily store programs executing on the MCU, and a Universal Asynchronous Receiver Transmitter (UART) connection 213, which may be used to transfer information to and from the flash memory 201. The UART connection 213 may use, e.g., an industry standard RS-232 type wired connection, a wireless connection, a modem interface, or any other like interface to communicate with an external code source (not shown). The CPU rewrite code 209, UART connection 213, and RAM 211 are used by the MCU to program (or reprogram) the correction block(s) 203 using information from the external code source. This process is best described in conjunction with FIG. 3.

FIG. 3 is a flow chart depicting a manner in which the correction block may be programmed according to one aspect of the invention. The process starts at block 301. A rewrite of the correction block(s) 203 is first initiated by the MCU at step 303. This initialization may occur, e.g., as a result of a detection by the MCU that an external code source is connected to the UART connection 213, or as a result of a specific command communicated directly to the MCU. Alternatively, initialization may occur as a result of scheduled maintenance routines executing in the MCU, where the MCU periodically accesses, e.g., via a modem connection, a central repository where error correction code may be stored. If new correction code is detected in the repository, the MCU will initialize the CPU rewrite process.

Once initialization occurs, the MCU copies the CPU rewrite program or code 209 to the RAM 211. This rewrite code 209 allows the MCU to manage the programming and reprogramming of code into the correction block(s) 203 of the flash memory 201. The rewrite program may be designed specifically to download correction code from a particular type of remote access system. Once loaded into the RAM 211, the rewrite program 209 is then executed at step 307. A determination is made at step 309 as to which correction block(s) 203 are to be used to store the correction code. If multiple correction blocks 203 are available in the flash memory 201 for storing the correction code, the CPU rewrite program 209 enables the MCU to determine which block or blocks of flash memory are to be used to store the downloaded code. The selected correction block(s) is/are then erased at step 311. After erasure, transfer of the correction code is initiated from the external source (not shown) by way of the UART connection 213 into the flash memory 201 at step 313. When the transfer is complete, the CPU rewrite program 209 initiates a jump to an address match interrupt subroutine or a reset (a lesser reset than a full reset of the MCU) of the MCU at step 315. The rewrite code 209 may then be purged from the RAM 211.

The address match interrupt subroutine or reset begins the process of generating and enabling address match interrupts for each of the correction code blocks that have been downloaded into the flash memory 201. The interrupts are the mechanism by which the correction code modules, stored in the correction block(s) 203 of the flash memory 201, are executed during program operation instead of the program instructions 205 that are to be replaced.

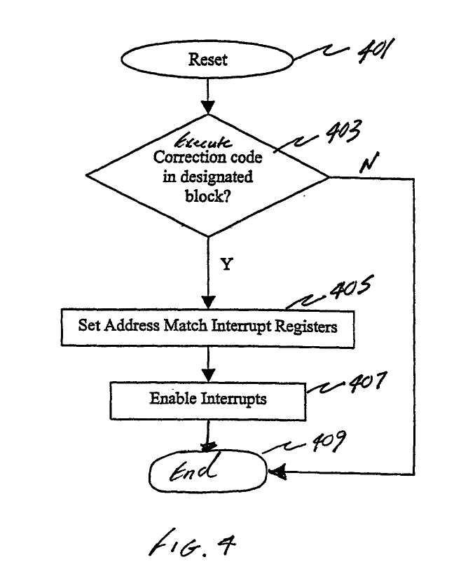

FIG. 4 depicts an exemplary manner in which address match interrupts are generated and enabled by the MCU. The process begins at step 401 with a triggering of the address match interrupt subroutine or reset of the flash memory based MCU. Next, a determination is made as to which correction block(s) 203 have either new or modified correction code stored in them. According to an exemplary embodiment, an address match decision data value may be stored at the beginning of each of the correction blocks allocated in the flash memory to indicate whether or not a particular correction block contains a correction block to be patched into the main program. If, for example, the address match decision data value for a given correction block is set, then an address match interrupt register will be set up for that particular correction block. Each of the available correction blocks are checked in this manner whenever an address match interrupt reset occurs.

Continuing at step 403 of FIG. 4, if it is determined that either new or modified correction code has been downloaded to the various correction blocks 203 of the flash memory 201, then corresponding address match interrupt registers are updated for each of the identified new or modified patches at step 405. These interrupt registers are updated with a address match correction start address that is stored in the correction block(s) 203 along with the remaining downloaded correction code. The address match correction start address represents an address in the software program 205 that is to be patched where instructions are to be executed from the correction block(s) rather than from the software program 205 itself. After the interrupt registers are updated, the address match interrupts are then enabled at step 407, and the process ends at step 409. Once the interrupts are enabled, the MCU will be able to branch to and execute the correction code instructions whenever the program counter matches a address match correction start address stored in one of the interrupt registers.

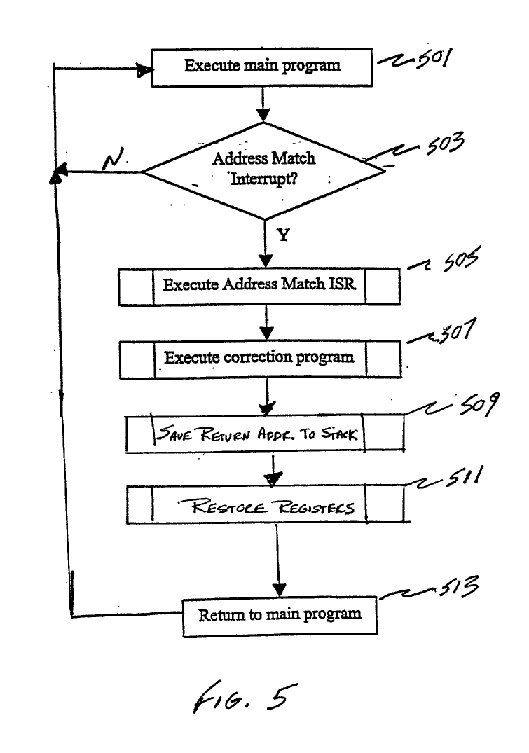

Execution of a program in the MCU with address match interrupt capability enabled is depicted in FIG. 5. Program execution from main memory begins at step 501 of the flow diagram and continues until an address match interrupt is triggered at step 503. The triggering of an address match interrupt occurs whenever the current program counter matches one of the various address match correction start address entries stored in the address match interrupt registers. If an address match interrupt is not triggered at step 503, then normal program operation continues at step 501. If an address match interrupt is triggered at step 503, however, an address match ISR is then executed at step 505.

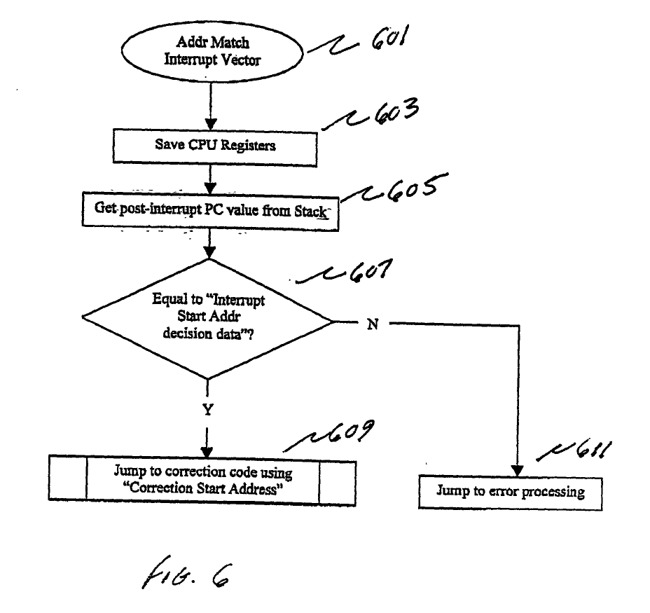

FIG. 6 provides an exemplary flow chart diagraming the steps performed by the address match ISR. The address match ISR is invoked at step 601 using a corresponding address match entry in the vector table 109. Following the triggering of the address match interrupt, all CPU registers holding the post-interrupt status (e.g. the program counter) are saved, e.g., to the program stack or perhaps to RAM, at step 603. Next, the post-interrupt program counter value is retrieved at step 605. This program counter value is then compared with an interrupt start address decision data value stored in each of the enabled correction blocks 203 at step 607.

The value of the interrupt start address decision data stored in each of the correction blocks is equal to the address stored in the corresponding address match interrupt register, plus an offset value. The value of the offset depends on the next instruction to be executed at the time the address match occurs. For example, certain instructions may require offsets of “+2” , whereas other instructions may require only an offset of “+1”.

Returning to step 607 of FIG. 6, when one of the interrupt start address decision data values matches the post-interrupt value of the program counter retrieved from the stack, this correction block having the matching decision data value is identified as the correction block that triggered the address match interrupt. A correction start address is then read from the matching correction block, and the address match ISR uses this start address to branch the program execution to the beginning of the correction code block at step 609. If at step 607, however, none of the interrupt start address decision data values stored in each of the correction blocks matches the post-interrupt value of the program counter retrieved from the stack, then the address match ISR jumps to an error processing routine at step 611.

Having described the operation of the address match ISR, attention is directed back to FIG. 5, where execution of the correction program is shown at step 507. After the correction code has been executed, the return from interrupt destination address saved to the stack by the address match ISR at step 603, is overwritten with the correction return address stored in the corresponding correction block at step 509. The overwriting of the return destination address may be performed by either the address match ISR or by the code stored in the correction block itself. Performing this function in the correction block code reduces processing time by avoiding unnecessary module switching. Next, the registers saved by the ISR at step 603 are restored at step 511. A return from interrupt command is then generated at step 513. The MCU uses the return from interrupt destination address (i.e., the correction return address), stored to the stack at step 509, to return program execution to the appropriate location within the main software program 205. Normal execution of the software program 205 continues from this point, or until another address match interrupt is detected at step 503, wherein the steps of executing the appropriate correction code instructions are repeated.

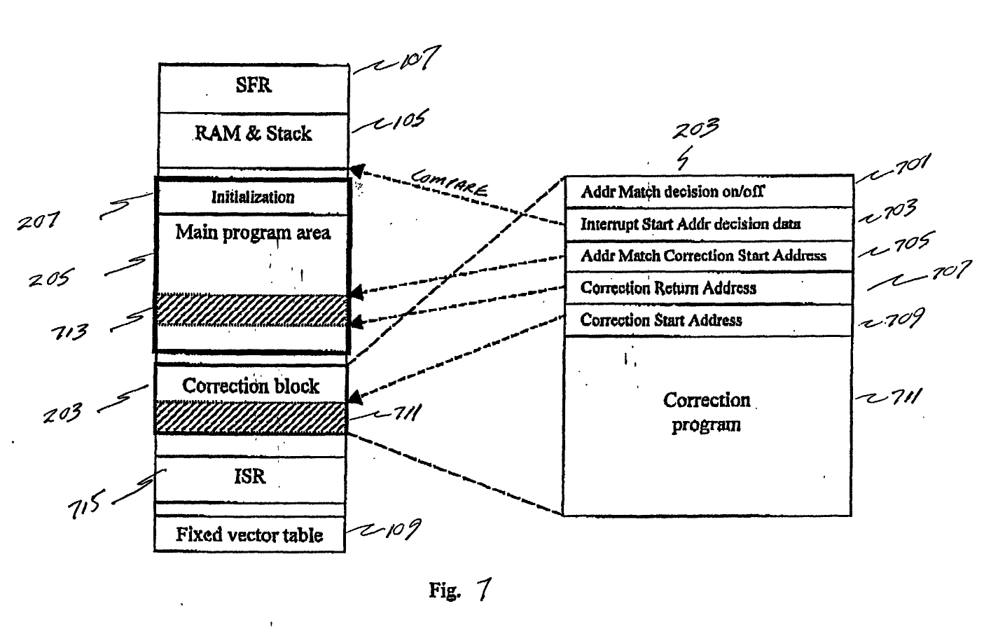

To better describe the various data and addresses that may be included in a correction block, a more detailed description of the memory map shown in FIGS. 1 and 2, including an exemplary correction block structure, is presented in FIG. 7. The correction block 203 shown in this figure includes a correction program 711 used by the address match interrupt routine to replace a portion 713 of a main program 205. Also included in the block is an address match decision data value 701, that may be used by the address match initialization code 207 at step 403 of FIG. 4 to determine if correction code is stored in the correction block 203. The correction block further includes the interrupt start address decision data value 703 that may be used by the address match ISR 715 at step 607 of FIG. 6 to determine which correction block address match correction start address triggered an address match interrupt. Recall that this decision data value 703 is compared with the value of the program counter stored to the stack when an interrupt is triggered. The decision data value 703 is typically equal to an address match correction start address 705, plus one or two program counts, depending on the next instruction to be executed at the time an interrupt is triggered.

The address match correction start address 705 represents the address at which instructions in the main program 205 are to be replaced with instructions stored in the correction program 711. The address match correction start address 705 is stored in an address match interrupt register during address match initialization at step 405 of the process shown in FIG. 4.

Also included in the correction block 203 is a correction start address 707 and a correction start address 709. The correction start address 709 is used by the address match ISR 715 to branch to the appropriate place in the correction program as depicted in step 609 of the process shown in FIG. 6. The correction return address 707, is used to overwrite the return from interrupt destination address as described in conjunction with step 509 of FIG. 5. The return from interrupt destination address is used to return program operation to the main program at the correction return address 707, thereby effecting a patch of the portion 713 of the main program by the address match interrupt routine.

The various aspects of the invention have been described in connection with a number of exemplary embodiments. To facilitate an understanding of the invention, many aspects of the invention were described in terms of sequences of actions to be performed by elements of a microprocessor based system. It will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

It will be readily apparent to those skilled in the art that it is possible to embody the invention in specific forms other than those of the exemplary embodiments described above. This may be done without departing from the essence of the invention. The exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for dynamically modifying a stored program, the method comprising the steps of:
storing correction code in at least one of a plurality of correction blocks included in an electrically erasable programmable memory;
executing a program having instructions stored in the memory;
invoking an address match routine to execute at least a portion of the correction code in place of at least one of the instructions during the executing of the program; and
continuing executing the program after the at least a portion of the correction code executes.

2. The method of claim 1, wherein the step of invoking an address match routine occurs when a program counter associated with the executing of the program matches at least one of a plurality of address match registers.

3. The method of claim 2, further comprising the steps of:
determining for each of the correction blocks whether correction code stored in the blocks is to be executed during the executing of the program;
retrieving a first address from the correction code stored in a respective correction block when it is determined that correction code stored in the respective correction block is to be executed during program execution; and
storing the retrieved first address in one of the plurality of address match registers.

4. The method of claim 3, wherein the step of determining for each of the correction blocks whether correction code stored in a respective correction block is to be executed during program execution comprises the steps of:
retrieving a first data value from each of the correction blocks having stored correction code;
comparing the retrieved first data value from each of the correction blocks having stored correction code to a predetermined value; and
determining that the correction code stored in each of the correction blocks is to be executed during program execution when the corresponding first data value equals the predetermined value, otherwise determining that the correction code stored in each of the correction blocks is not to be executed during program execution.

5. The method of claim 2, wherein the step of determining for each of the correction blocks whether correction code stored in the blocks is to be executed during the executing of the program occurs in response to a completion of the storing of correction code in at least one of a plurality of correction blocks.

6. The method of claim 2, further comprising the steps of:
saving a plurality of registers and the program counter upon the invoking of the address match routine to preserve a post address match program status;
retrieving a second data value from each of the correction blocks having stored correction code;
comparing the retrieved second data value from each of the correction blocks having stored correction code to a post address match value of the program counter; and
identifying the correction block corresponding to the invoking of the address match routine as the correction block having the second data value equal to the post address match value of the program counter.

7. The method of claim 6, further comprising the step of:
branching to an error processing routine when no retrieved second data value is equal to the post address match value of the program counter.

8. The method of claim 6, wherein the second data value is equal to the value stored in the address match register corresponding to the invoking of the address match routine plus an offset value.

9. The method of claim 8, wherein the offset value is dependent upon a next program instruction to be executed at the time of the invoking of the address match routine.

10. The method of claim 6, wherein the step of continuing executing the program after the at least a portion of the correction code executes comprises the steps of:
retrieving a third address from the correction code identifying a return address within the program;
restoring the plurality of registers saved upon the invoking of the address match routine to reinstate a post address match program status;
branching the executing of the program to the third address; and
executing the program having instructions stored in the memory beginning at the third address.

11. The method of claim 1, wherein the invoking of the address match routine is carried out by an address match interrupt service routine having a corresponding address match interrupt entry in a vector table stored in the memory.

12. The method of claim 1, wherein to execute at least a portion of the correction code, the address match routine comprises the steps of:
retrieving a second address from the correction code identifying a starting address within the at least a portion of correction code;
branching the executing of the program to the second address; and
executing the at least a portion of the correction code beginning at the second address.

13. The method of claim 1, wherein instructions for continuing executing the program after the at least a portion of the correction code executes are included in the correction code.

14. The method of claim 1, wherein the step of storing correction code in at least one of a plurality of correction blocks comprises the steps of:
selecting at least one of the plurality of correction blocks for storing the correction code;
erasing the selected at least one memory correction block; and
transferring the correction code from an external source to the selected at least one of the plurality of correction blocks.

15. The method of claim 14, wherein the correction code is transferred from the external source by at least one of a wired and a wireless connection.

16. The method of claim 1, wherein the step of storing correction code in at least one of a plurality of correction blocks occurs in response to at least one of a detection that an external source is coupled to the memory and an invocation of a periodically scheduled maintenance routine.

17. A micro-controller capable of dynamically modifying a stored program, the micro-controller comprising:
electrically erasable programmable memory;
logic that stores correction code in at least one of a plurality of correction blocks included in the memory;
logic that executes a program having instructions stored in the memory;
logic that invokes an address match routine to execute at least a portion of the correction code in place of at least one of the instructions during the executing of the program; and
logic that continues executing the program after the at least a portion of the correction code executes.

18. The micro-controller of claim 17, wherein the logic that invokes an address match routine is responsive to a matching of a program counter associated with the executing of the program and at least one of a plurality of address match registers.

19. The micro-controller of claim 18, further comprising:
logic that determines for each of the correction blocks whether correction code stored in the blocks is to be executed during the executing of the program;
logic that retrieves a first address from the correction code stored in a respective correction block when it is determined that correction code stored in the respective correction block is to be executed during program execution; and
logic that stores the retrieved first address in one of the plurality of address match registers.

20. The micro-controller of claim 19, wherein the logic that determines for each of the correction blocks whether correction code stored in a respective correction block is to be executed during program execution comprises:
logic that retrieves a first data value from each of the correction blocks having stored correction code;
logic that compares the retrieved first data value from each of the correction blocks having stored correction code to a predetermined value; and
logic that determines that the correction code stored in each of the correction blocks is to be executed during program execution when the corresponding first data value equals the predetermined value, otherwise determining that the correction code stored in each of the correction blocks is not to be executed during program execution.

21. The micro-controller of claim 18, wherein the logic that determines for each of the correction blocks whether correction code stored in the blocks is to be executed during the executing of the program is responsive to a completion of the storing of correction code in at least one of a plurality of correction blocks.

22. The micro-controller of claim 18, further comprising:
logic that saves a plurality of registers and the program counter upon the invoking of the address match routine to preserve a post address match program status;
logic that retrieves a second data value from each of the correction blocks having stored correction code;
logic that compares the retrieved second data value from each of the correction blocks having stored correction code to a post address match value of the program counter; and
logic that identifies the correction block corresponding to the invoking of the address match routine as the correction block having the second data value equal to the post address match value of the program counter.

23. The micro-controller of claim 22, further comprising:
logic that branches to an error processing routine when no retrieved second data value is equal to the post address match value of the program counter.

24. The micro-controller of claim 22, wherein the second data value is equal to the value stored in the address match register corresponding to the invoking of the address match routine plus an offset value.

25. The micro-controller of claim 24, wherein the offset value is dependent upon a next program instruction to be executed at the time of the invoking of the address match routine.

26. The micro-controller of claim 22, wherein the logic that continues executing the program after the at least a portion of the correction code executes comprises:
logic that retrieves a third address from the correction code identifying a return address within the program;
logic that restores the plurality of registers saved upon the invoking of the address match routine to reinstate a post address match program status;
logic that branches the executing of the program to the third address; and
logic that executes the program having instructions stored in the memory beginning at the third address.

27. The micro-controller of claim 17, wherein the logic that invokes the address match routine is responsive to an address match interrupt service routine having a corresponding address match interrupt entry in a vector table stored in the memory.

28. The micro-controller of claim 17, further comprising:
logic that retrieves a second address from the correction code identifying a starting address within the at least a portion of correction code;
logic that branches the executing of the program to the second address; and
logic that executes the at least a portion of the correction code beginning at the second address.

29. The micro-controller of claim 17, wherein instructions for continuing executing the program after the at least a portion of the correction code executes are included in the correction code.

30. The micro-controller of claim 17, wherein the logic that stores correction code in at least one of a plurality of correction blocks comprises:
logic that selects at least one of the plurality of correction blocks for storing the correction code;
logic that erases the selected at least one memory correction block; and
logic that transfers the correction code from an external source to the selected at least one of the plurality of correction blocks.

31. The micro-controller of claim 30, wherein the correction code is transferred from the external source by at least one of a wired and a wireless connection.

32. The micro-controller of claim 17, wherein the logic that stores correction code in at least one of a plurality of correction blocks is responsive to at least one of a detection that an external source is coupled to the memory and an invocation of a periodically scheduled maintenance routine.

33. The micro-controller of claim 17, wherein the electrically erasable programmable memory is included on at least one of a same electronic chip as the remaining logic comprising the micro-controller and a different electronic chip as the remaining logic comprising the micro-controller.

34. An electrically erasable programmable memory based memory map structure supporting an address match interrupt scheme, the memory comprising:
a plurality of correction blocks for storing correction code;
a random access memory (RAM) area including a program stack for temporarily storing program information;
a main program area for storing at least one executable program;
an initialization area for storing code to enable an address match interrupt for at least one of the correction blocks;
a special function register (SFR) area including a plurality of address interrupt registers;
a vector table for triggering the address match interrupt when a program counter associated with the at least one executable program matches a register value stored in one of the plurality of address interrupt registers; and
an interrupt service routine (ISR) area including an address match ISR;
wherein the address match ISR identifies which one of the plurality of correction blocks corresponds to the triggering of the address match interrupt to execute at least a portion of the correction code in place of at least one instruction of the at least one executable program during program execution.

35. The structure of claim 34, wherein each of the correction blocks comprise:
a first data value for determining whether correction code stored in the correction block is to be executed during program execution;
a second data value for identifying which one of the plurality of correction blocks corresponds to the triggering of the address match interrupt;
a first address identifying a location of the portion of the executable program replaced by the at least a portion of the correction code;
a second address identifying a starting address of the at least a portion of the correction code to be executed in place of the least a portion of the executable program; and
a third address identifying a return address within the executable program where program execution is continued after execution of the at a portion of the correction is completed.
